(19) United States
(12) Patent Application Publication
(10) Pub. No.: US 2025/0094842 A1
(43) Pub. Date: Mar. 20, 2025

(54) INTELLIGENT ORCHESTRATION SYSTEM FOR EMOTION CONTAGION IN MULTI-HUMAN TO MULTI-AGENT INTERACTIONS

(71) Applicant: International Business Machines Corporation, Armonk, NY (US)

(72) Inventors: Fernando Luiz Koch, palm Beach Gardens, FL (US); Martin G. Keen, Cary, NC (US); Jessica Nahulan, Markham, CA (US); Jeremy R. Fox, Georgetown, TX (US)

(73) Assignee: International Business Machines Corporation, Armonk, NY (US)

(21) Appl. No.: 18/370,171

(22) Filed: Sep. 19, 2023

(51) Int. Cl. G06N 5/043

(52) U.S. Cl. CPC G06N 5/043

(57) ABSTRACT

An embodiment senses an interaction among a software agent and a plurality of humans, responsive to the sensed interaction, computes a mood pattern in a Mood Pattern Observation Component based on the sensed interaction. The embodiment computes a prevalent mood pattern in a Mood Pattern Grouping Component based on the mood pattern. The embodiment decides by an Orchestration of Agent Interactions Component based on the prevalent mood pattern to adapt a response of the software agent to influence at least one of the plurality of humans towards the prevalent mood pattern, the deciding further comprises training a Text Generation Component to generate a text sequence based on the response wherein the software agent emits the text sequence and the sensed interaction among the software agent and the plurality of humans is updated with the text sequence.

### BACKGROUND

The present invention relates generally to artificial intelligence. More particularly, the present invention relates to a method, system, and computer program for An Intelligent Orchestration System for Emotion Contagion in Multi-Human to Multi-Agent Interactions.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

In today's digital age, multi-human to multi-software agent interactions are becoming increasingly commonplace. From virtual assistants to customer service chatbots, humans are interacting with agents more frequently than ever before. However, these interactions often lack the emotional depth and nuance of human-to-human interactions, leading to a range of negative outcomes such as decreased satisfaction, increased frustration, and even anger. Furthermore, these interactions can also have a profound impact on the mood and emotions of humans, leading to a negative cycle of emotion contagion.

Current techniques of software agent to human interactions focus on accurately and correctly responding to human inquiries but not on improving the emotional depth and nuance of the interactions. Therefore, these techniques do not address facilitating positive emotion contagion in multi-human to multi-software agent interactions.

### SUMMARY

The illustrative embodiments provide for An Intelligent Orchestration System for Emotion Contagion in Multi-Human to Multi-Agent Interactions. An embodiment includes sensing an interaction among a software agent and a plurality of humans, responsive to the sensed interaction, computing a mood pattern in a Mood Pattern Observation Component based on the sensed interaction. The embodiment also includes computing a prevalent mood pattern in a Mood Pattern Grouping Component based on the mood pattern. The embodiment also includes deciding by an Orchestration of Agent Interactions Component based on the prevalent mood pattern to adapt a response of the software agent to influence at least one of the plurality of humans towards the prevalent mood pattern, the deciding further comprising training a Text Generation Component to generate a text sequence based on the response wherein the software agent emits the text sequence and the sensed interaction among the software agent and the plurality of humans is updated with the text sequence. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 diagram in accordance with an illustrative embodiment;

FIG. 3 depicts a component diagram in accordance with an illustrative embodiment;

FIG. 4 depicts a component diagram in accordance with an illustrative embodiment;

FIG. 5 depicts a component diagram in accordance with an illustrative embodiment;

FIG. 6 depicts a component diagram in accordance with an illustrative embodiment;

FIG. 7 depicts a component diagram in accordance with an illustrative embodiment;

FIG. 8 depicts a system diagram in accordance with an illustrative embodiment; and

FIG. 9 depicts a flowchart diagram of an example On Demand process in accordance with an illustrative embodiment.

### DETAILED DESCRIPTION

In today's digital age, multi-human to multi-software agent interactions such as a multi-user environment encompassing two or more human users of the technology are becoming increasingly commonplace. From virtual assistants to customer service chatbots, humans are interacting with software agents more frequently than ever before. However, these interactions often lack the emotional depth and nuance of human-to-human interactions, leading to a range of negative outcomes such as decreased satisfaction, increased frustration, and even anger. Furthermore, these interactions can also have a profound impact on the mood and emotions of humans, leading to a negative cycle of emotion contagion.

Current techniques of software agent to human interactions focus on accurately and correctly responding to human inquiries but not on improving the emotional depth and nuance of the interactions. Therefore, these techniques do not address facilitating positive emotion contagion in multi-human to multi-software agent interactions.

The present disclosure addresses the deficiencies described above by providing a method, a machine-readable medium, and a system for An Intelligent Orchestration System for Emotion Contagion in Multi-Human to Multi-Agent Interactions. Embodiments described herein describe sensing an interaction among a software agent and a plurality of humans, responsive to the sensed interaction, computing a mood pattern in a Mood Pattern Observation Component based on the sensed interaction. The embodiment also includes computing a prevalent mood pattern in a Mood Pattern Grouping Component based on the mood pattern. The embodiment also includes deciding by an Orchestration of Agent Interactions Component based on the prevalent mood pattern to adapt a response of the software agent to influence at least one of the plurality of humans towards the prevalent mood pattern, the deciding further comprising training a Text Generation Component to generate a text sequence based on the response wherein the software agent emits the text sequence and the sensed interaction among the software agent and the plurality of humans is updated with the text sequence.

Illustrative embodiments include wherein the deciding by the Orchestration of Agent Interactions Component further comprises inputting a prompt into a machine learning model wherein the prompt is based in part on the prevalent mood pattern.

Illustrative embodiments include wherein the computing the prevalent mood pattern in the Mood Pattern Grouping Component further comprises sensing an intensity and a duration of the mood pattern.

Illustrative embodiments include wherein computing the mood pattern in the Mood Pattern Observation Component comprises sensing a sentiment and an emotion from the sensed interaction.

Illustrative embodiments include wherein computing the prevalent mood pattern in the Mood Pattern Grouping Component comprises executing a clustering algorithm.

Illustrative embodiments include wherein the Text Generation Component comprises a sequence-to-sequence model.

Illustrative embodiments also include wherein the Orchestration of Agent Interactions Component comprises a feedback loop based in part on the mood pattern and the sensed interaction.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

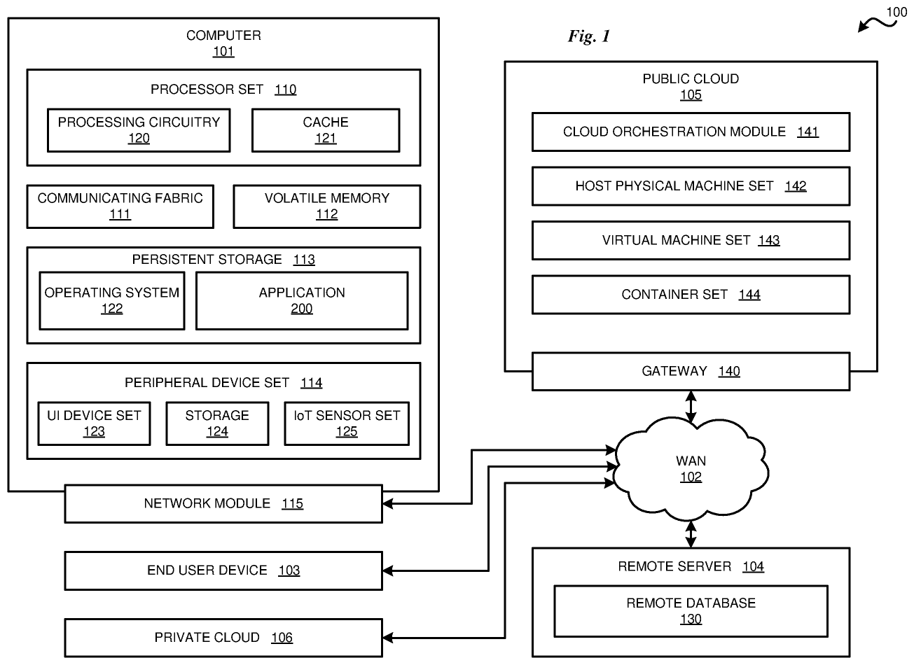

With reference to FIG. 1, this figure depicts a block diagram of a computing environment 100. Data center environment 100 contains an example of an environment for the execution of at least some of the computer code involved in performing the inventive methods, such as an Application module 200 that provides An Intelligent Orchestration System for Emotion Contagion in Multi-Human to Multi-Agent Interactions. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

The process software An Intelligent Orchestration System for Emotion Contagion in Multi-Human to Multi-Agent Interactions is shared, simultaneously serving multiple customers in a flexible, automated fashion. It is standardized, requiring little customization, and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time, such as minutes, seconds, and hours, on the central processor of the server. Additionally, the accessed server may make requests of other servers that require CPU units. CPU units are an example that represents but one measurement of use. Other measurements of use include, but are not limited to, network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use, such as network bandwidth, memory usage, storage usage, etc., approach a capacity so as to affect performance, additional network bandwidth, memory usage, storage, etc. are added to share the workload.

The measurements of use employed for each service and customer are sent to a collecting server that sums the measurements of use for each customer for each service that was processed anywhere in the network of servers that provide the shared execution of the process software. The summed measurements of use units are periodically multiplied by unit costs, and the resulting total process software application service costs are alternatively sent to the customer and/or indicated on a web site accessed by the customer, who may then remit payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

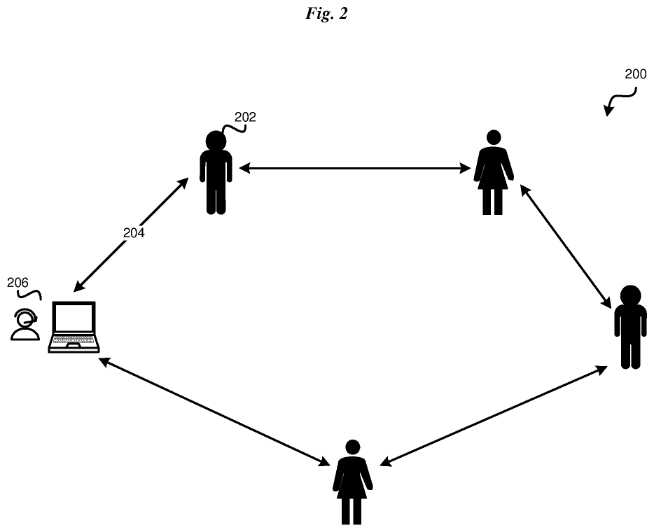

FIG. 2 depicts a diagram 200 in accordance with an illustrative embodiment. In a particular embodiment, the diagram 200 is representative of aspects of the application 200 of FIG. 1.

In the illustrated embodiment, the software agent 206 interacts 204 with multiple human users 202. In an embodiment, the interactions may be among multi-software agents and multi-humans, including software agent to agent or human to human interactions. Some embodiments are described as use cases below:

| Use Case 1 | Use Case 2 | Use Case 3 |
|---|---|---|
| Virtual Assistant for | Situation: | Industry: Healthcare |
| Customer Service | Social Media Platform for | Services |
| User: Lynnessa, a busy | Mental Health Support | Situation: Virtual Assistant |
| working mother | Situation: A user on a social | for Healthcare Services |
| Situation: Lynnessa is | media platform is | Application: The software |
| looking to purchase a new | experiencing negative | agent observes the |
| kitchen appliance and wants | emotions such as sadness | mood patterns of patients |
| to explore her options with a | and anger due to online | during |
| virtual assistant. | bullying. | telemedicine consultations |
| Application: The software | Application: The application | and adapts its |
| agent observes Lynnessa's | observes the user's mood | conversation style to |
| mood patterns during the | patterns and groups them | influence their mood |
| conversation and adapts its | based on their similarities. It | towards a defined prevalent |
| conversation style to | then orchestrates the | mood pattern. |
| influence her mood towards | interactions between other | For example, if a patient |
| a defined prevalent mood | users to influence the user's | expresses anxiety about their |
| pattern. For example, if | mood towards a defined | medical condition, |
| Lynnessa expresses | prevalent mood pattern, | the software agent can |
| frustration at the lack of | promoting a more positive | respond with empathy and |
| availability of certain | and engaging online | reassurance, leading |
| appliances, the virtual | community. For example, if | to increased satisfaction and |
| assistant can respond with | the user is expressing | a more positive experience |
| empathy and understanding, | feelings of sadness and | for the patient. |
| leading to increased | isolation, the application can | Additionally, the invention |
| satisfaction and a more | facilitate connections with | application can facilitate |
| positive experience for | other users who have | connections between |
| Lynnessa. | experienced similar | patients with similar mood |
| | emotions, leading to | patterns, promoting a more |
| | increased support and a | supportive online |
| | more positive experience for | community. |
| | the user. | |

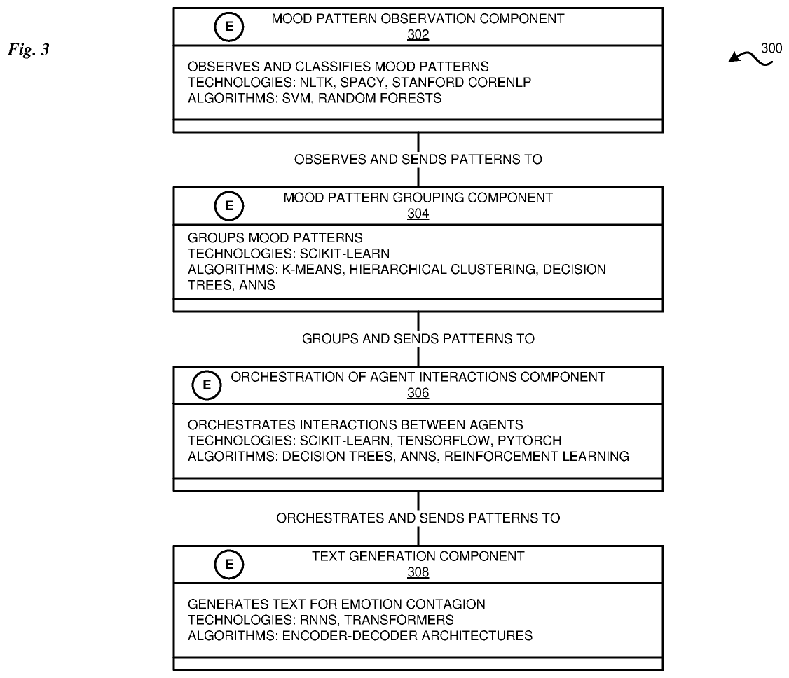

FIG. 3 depicts a component diagram 300 in accordance with an illustrative embodiment. In a particular embodiment, the components 300 are representative of aspects of the application 200 of FIG. 1.

In the illustrated embodiment, the Mood Pattern Observation Component 302 observes and classifies mood patterns using natural language technologies, and algorithms such as SVM. The Mood Pattern Observation Component 302 inputs mood patterns into the Mood Pattern Grouping Component 304 which groups mood patterns by executing clustering algorithms and decision trees. The Mood Pattern Grouping Component 304 groups and inputs prevalent mood patterns into the Orchestration of Agent Interactions Component 306 which orchestrates interactions between the software agent and users, training and executing decision trees, artificial neural networks (ANN) and reinforced learning. The Orchestration of Agent Interactions Component 306 orchestrates and inputs into the Text Generation Component 308 which generates text for emotion contagion comprising of training of recurrent neural networks and sequence to sequence models, and executing encoder-decoder algorithms.

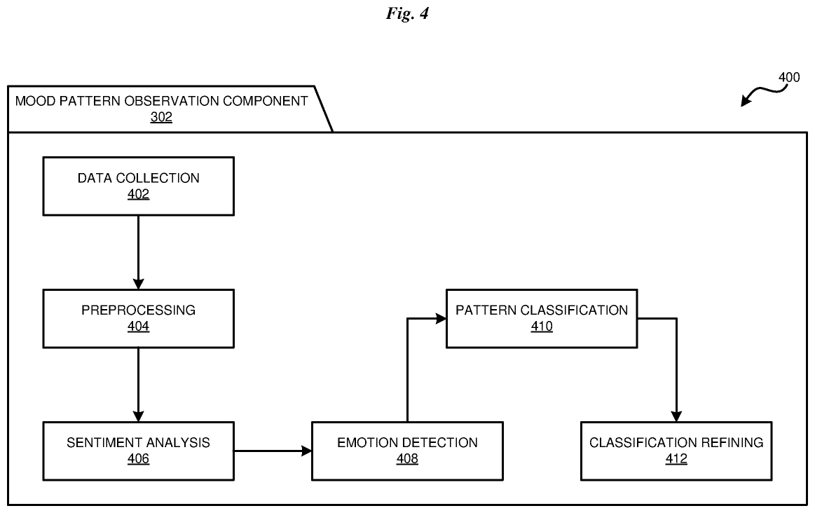

FIG. 4 depicts a component diagram 400 in accordance with an illustrative embodiment. In a particular embodiment, the components 400 are representative of aspects of the application 200 of FIG. 1.

In the illustrated embodiment, the Mood Pattern Observation Component 302 collects 402 text data from human-agent interactions using application programming interfaces (API) or webhooks. The component may use APIs to collect text data from social media platforms. Alternatively, the component may use webhooks to collect text data from the software agent or virtual assistants. The component preprocesses 404 the collected text data using natural language processing (NLP) techniques such as tokenization, stemming, and lemmatization. Tokenization involves breaking the text into individual words or phrases, while stemming and lemmatization involve reducing words to their base form.

In some embodiments, the mood pattern may be observed from the sentiment and emotions in the sensed text data captured from the interaction. The component analyzes the sentiment 406 of the preprocessed text data using machine learning algorithms such as Support Vector Machine (SVM). Sentiment analysis involves identifying the emotional tone of the text, whether it's positive, negative, or neutral. The component senses the emotions 408 expressed in the text data interactions using NLP techniques such as emotional intensity detection. Emotional intensity detection involves identifying the strength of the emotions expressed in the text, such as happiness, sadness, anger, or fear. The component classifies the observed mood patterns 410 into predefined categories based on their intensity and duration. For example, the system can classify mood patterns as positive, negative, or neutral based on the emotions expressed in the text data. The component refines the classification of mood patterns 412 using machine learning algorithms such as decision trees or ANNs. Decision trees involve creating a hierarchy of decisions based on the features of the text data, while ANNs involve creating a network of interconnected nodes to analyze the text data.

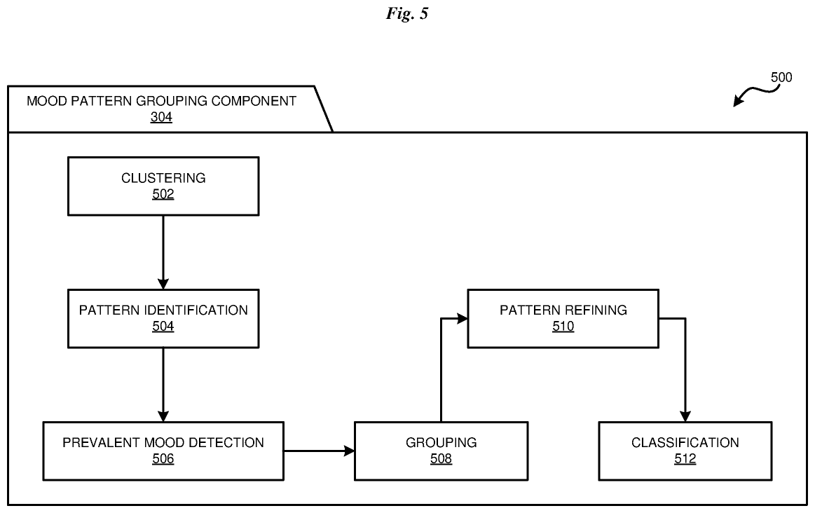

FIG. 5 depicts a component diagram 500 in accordance with an illustrative embodiment. In a particular embodiment, the components 500 are representative of aspects of the application 200 of FIG. 1.

In the illustrated embodiment, Mood Pattern Grouping Component 304 clusters 502 the observed mood patterns based on their similarities using clustering algorithms such as k-means or hierarchical clustering. This step helps identify common mood patterns among humans and agents. The component identifies common mood patterns 504 among humans and agents based on the clustered mood patterns. This step helps determine the prevalent mood pattern in a conversation. The component senses the prevalent mood pattern 506 in a conversation based on the intensity and duration of the mood patterns. This step helps identify the dominant emotion expressed in the conversation. The component groups the conversations 508 based on their prevalent mood patterns. This step helps organize the conversations into categories based on their emotional tone. The component also refines the grouping of conversations 510 based on their similarity using machine learning algorithms such as decision trees or ANNs. This step helps improve the accuracy of the grouping and ensure that similar conversations are grouped together. The component further classifies the grouped conversations 512 into predefined categories based on their intensity and duration. This step helps categorize the conversations into specific emotional states, such as positive, negative, or neutral.

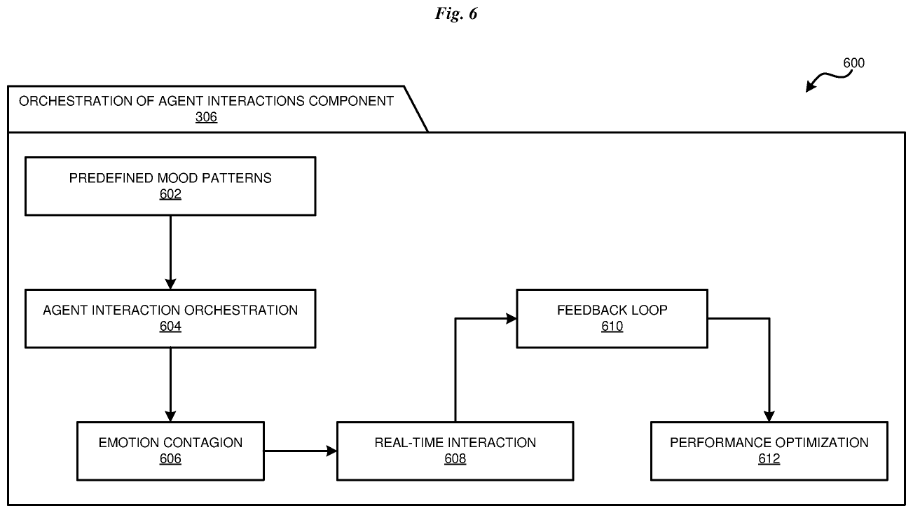

FIG. 6 depicts a component diagram 600 in accordance with an illustrative embodiment. In a particular embodiment, the components 600 are representative of aspects of the application 200 of FIG. 1.

In the illustrated embodiment, the Orchestration of Agent Interactions Component 306 defines predefined mood patterns 602 based on the observed mood patterns in human-agent conversations. These mood patterns can include emotions such as happiness, sadness, anger, and fear. The component orchestrates the interactions between software agents and users 604 based on the defined prevalent mood pattern using decision-making algorithms such as decision trees or ANNs. The orchestration will be done in real-time based on the observed mood patterns and the desired outcome of the conversation. The component enables emotion contagion 606 between humans and agents by adapting the conversation style of agents to influence the mood of humans towards the defined prevalent mood pattern. This can include using machine learning models such as language models or sequence-to-sequence models to generate appropriate responses from agents. The component facilitates real-time interaction 608 between humans and agents based on the orchestrated interactions. This can include using web sockets for real-time communication between humans and agents. The component also creates a feedback loop 610 where the observed mood patterns and sensed interactions can be used to refine the orchestration of agent interactions. This can include using reinforcement learning algorithms to optimize the performance of the orchestration based on real-time feedback. The component further optimizes the performance of the orchestration 612 using machine learning algorithms such as reinforcement learning. This can include using A/B testing or multivariate testing to optimize the conversation flow and improve the overall experience for users.

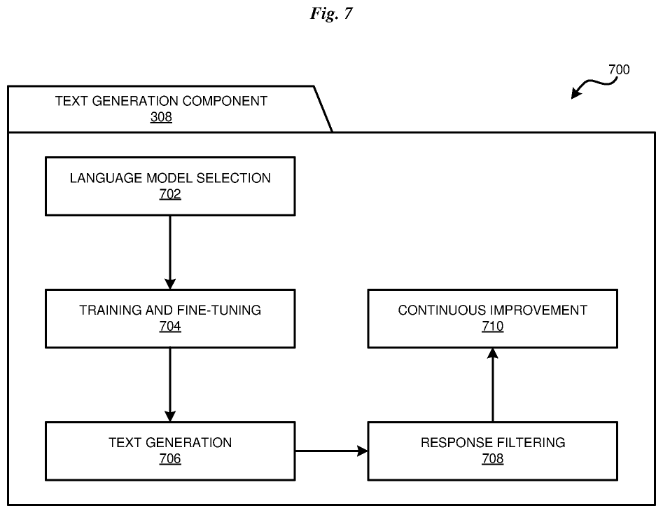

FIG. 7 depicts a component diagram 700 in accordance with an illustrative embodiment. In a particular embodiment, the components 700 are representative of aspects of the application 200 of FIG. 1.

In the illustrated embodiment, the Text Generation Component 308 selects a language model 702 such as sequence-to-sequence models or recurrent neural networks (RNNs) for generating appropriate text contact. Sequence-to-sequence models are preferred for their ability to generate coherent and contextually relevant text responses. The component trains and fine-tunes the selected language model 704 using a dataset of human-agent conversations and their corresponding mood patterns. The training process involves optimizing the model's parameters to maximize the likelihood of generating appropriate text contact given the observed mood pattern and context. The component generates appropriate text contact 706 for emotion contagion based on the observed mood patterns using the trained and fine-tuned language model. The generated text responses are filtered based on their relevance, coherence, and appropriateness to the context of the conversation. The component also filters 708 the generated text responses based on their relevance, coherence, and appropriateness to the context of the conversation. This involves using NLP techniques such as sentiment analysis and emotional intensity detection to assess the effectiveness of the generated text contact in inducing the desired mood pattern in humans. In an embodiment, the generated text is emitted by the software agent and the sensed interaction updated with the generated text. The component further continuously improves 710 the language model and text generation capabilities based on user feedback and conversation data. This involves updating the training dataset with new conversations and mood patterns, and fine-tuning the language model to better capture the nuances of human communication.

In another embodiment, consider that are 3 humans talking to one Digital Assistant with the following profile distribution from the Method Mood Pattern Grouping Component:

Human 1: chatty, happy, currently in good mood, very interested in current topic X, seems knowledgeable about X, Y, Z.

Human 2: shy, happy, neural or undefined mood, interested in topic X, knowledgeable about Y, Z.

Human 3: neutral, neutral, currently disengaged, not interested in topic X, knowledgeable about Z.

Human 1 makes a joke attempting to reengage Human 3.

How can the Digital Agent help to contagion the emotion from Human 1 to Human 3?

Step 1: Identify the intention for Human-Human emotion contagion
Considering that the models are already classified (from previous method)
Classify the interaction from Human 1 (making the joke) as a possible tentative to engage and happy-up Human 3.

Step 2: Classify the process intended by Human-Human interaction, once identified
The interaction was a joke or humorous message.
The intent must be to cheer-up the neutral/disengaged Human 3.
Identify the shortcomings of Human 3 in this context->Lack of interest, neutral mood, etc.
For example, this may be implemented based on a combination between rule-base and Large AI models, through a process of Prompt engineering:
   Meta-prompt: Consider there are two human interactions through this channel. Human 1 is a {defined profile}. Human 3 is a {defined profile}. Human 1 cracked a joke about X intended to motivate and engage Human 3.
   Prompt: What are the possible shortcomings of Human 3 that Human 1 is trying to address?
   Answer: {inferred shortcomings}

Step 3: Identify possible interactions that Digital Assistant can inject in the conversation to support Human 1-Human 3 contagion.
This could be implemented based on a combination between rule-base and Large AI models, through a process of Prompt engineering:
   Meta-prompt: Consider there are two human interactions through this channel. Human 1 is a {defined profile}. Human 3 is a {defined profile}. Human 1 made a joke about X intended to motivate and engage Human 3.
   Consider that Human 1 tried to address the shortcomings {inferred shortcomings} of Human 3.
   Prompt: What are the possible interactions that Digital Assistant can inject in the conversation to support Human 1-Human 3 contagion.
   Answer: {inferred interactions}

Step 4: Convert proposed interactions into a Plan of Action for interaction P1, P2, P3
This could be achieved by a rule-based system to convert the proposed actions into a sequence of ruled-actions.

Step 5: Validate P1, P2, P3 as interactions to Human-X
This could be achieved by a rule-based system to validate interaction P* for Human-X, considering profile, context, etc.

Step 6: Convert P* into a Conversation Interaction which is emitted by the Digital Assistant and presented to Human-X
This may be achieved through large language model (LLM) using the meta-prompts above and a prompt on “convert P1 into a conversation statement for Human-3 in current context”.

Step 7: Feedback Loop:
Observed variations of mood patterns after the interactions to refine the orchestration rules applied in the steps above.
This may include using reinforcement learning algorithms to optimize the performance of the orchestration based on real-time feedback.

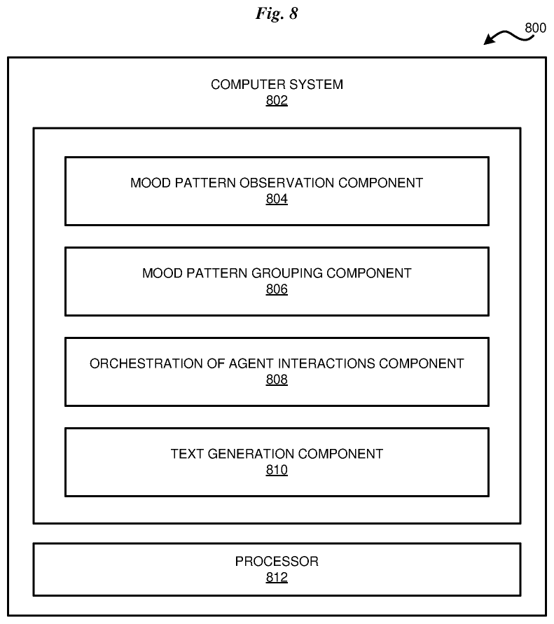

FIG. 8 depicts a system diagram 800 in accordance with an illustrative embodiment. In a particular embodiment, the components 800 are representative of aspects of the application 200 of FIG. 1.

In the illustrated embodiment, the computer system 802 comprising a processor 812 executes the Mood Pattern Observation Component 804, the Mood Pattern Grouping Component 806, the Orchestration of Agent Interactions Component 808, and the Text Generation Component 810.

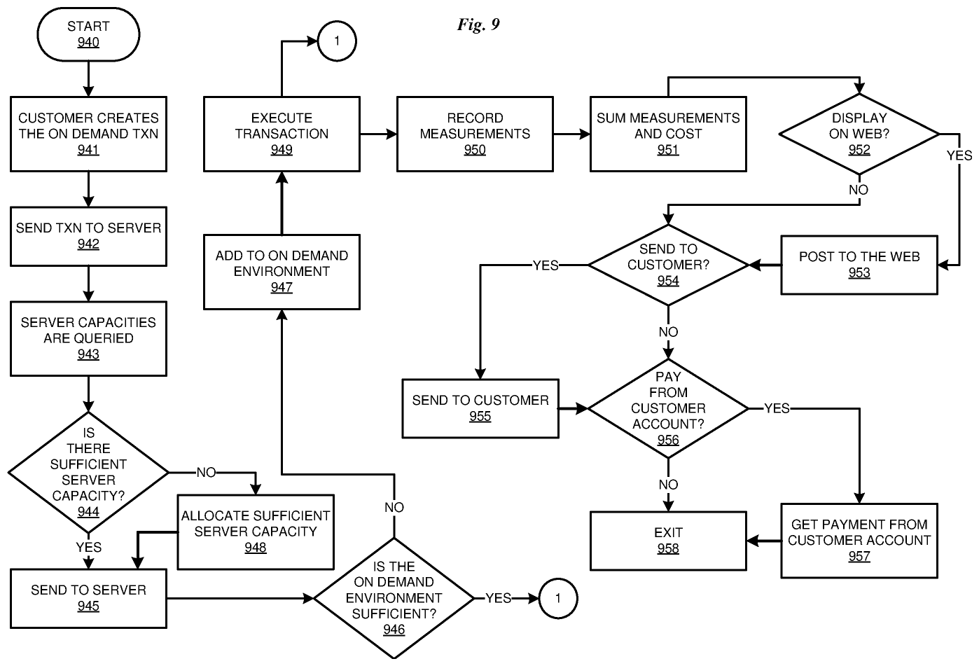

FIG. 9 depicts a flowchart diagram of an example On Demand process in accordance with an illustrative embodiment.

Step 940 begins the On Demand process. A transaction is created that contains the unique customer identification, the requested service type, and any service parameters that further specify the type of service (941). The transaction is then sent to the main server (942). In an On Demand environment, the main server can initially be the only server, and then as capacity is consumed other servers are added to the On Demand environment.

The server central processing unit (CPU) capacities in the On Demand environment are queried (943). The CPU requirement of the transaction is estimated, and then the server's available CPU capacity in the On Demand environment is compared to the transaction CPU requirement to see if there is sufficient CPU available capacity in any server to process the transaction (944). If there is not sufficient server CPU available capacity, then additional server CPU capacity is allocated to process the transaction (948). If there was already sufficient available CPU capacity, then the transaction is sent to a selected server (945).

Before executing the transaction, a check is made of the remaining On Demand environment to determine if the environment has sufficient available capacity for processing the transaction. This environment capacity consists of such things as, but not limited to, network bandwidth, processor memory, storage etc. (946). If there is not sufficient available capacity, then capacity will be added to the On Demand environment (947). Next the required software to process the transaction is accessed, loaded into memory, and then the transaction is executed (949).

The usage measurements are recorded (950). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs, and then recorded as a charge to the requesting customer (951).

If the customer has requested that the On Demand costs be posted to a web site (952), then they are posted thereto (953). If the customer has requested that the On Demand costs be sent via e-mail to a customer address (954), then they are sent (955). If the customer has requested that the On Demand costs be paid directly from a customer account (956), then payment is received directly from the customer account (957). On Demand process proceeds to 958 and exits.

While it is understood that the process software An Intelligent Orchestration System for Emotion Contagion in Multi-Human to Multi-Agent Interactions may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

### Introduction

Loading the process software directly on the client, server, and proxy computers by loading a storage medium such as a CD, DVD, etc.
Automatically or semi-automatically deploying the process software into a computer system by sending it to a central server or a group of central servers. The process software is then downloaded into the client computers that will execute the process software.
Sending the process software directly to the client system via e-mail. The process software is then either detached to a directory or loaded into a directory by executing a set of program instructions that detaches the process software into a directory.
Sending the process software directly to a directory on the client computer hard drive.
When there are proxy servers, the process will select the proxy server code, determine on which computers to place the proxy servers' code, transmit the proxy server code, and then install the proxy server code on the proxy computer. The process software will be transmitted to the proxy server and then it will be stored on the proxy server.

### General Description

While it is understood that the process software An Intelligent Orchestration System for Emotion Contagion in Multi-Human to Multi-Agent Interactions may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
sensing an interaction among a software agent and a plurality of humans, responsive to the sensed interaction, computing a mood pattern in a Mood Pattern Observation Component based on the sensed interaction;
computing a prevalent mood pattern in a Mood Pattern Grouping Component based on the mood pattern; and
deciding by an Orchestration of Agent Interactions Component based on the prevalent mood pattern to adapt a response of the software agent to influence at least one of the plurality of humans towards the prevalent mood pattern, the deciding further comprising:
training a Text Generation Component to generate a text sequence based on the response wherein the software agent emits the text sequence and the sensed interaction among the software agent and the plurality of humans is updated with the text sequence.

2. The computer-implemented method of claim 1, wherein the deciding by the Orchestration of Agent Interactions Component further comprises inputting a prompt into a machine learning model wherein the prompt is based in part on the prevalent mood pattern.

3. The computer-implemented method of claim 1, wherein the computing the prevalent mood pattern in the Mood Pattern Grouping Component further comprises sensing an intensity and a duration of the mood pattern.

4. The computer-implemented method of claim 1, wherein computing the mood pattern in the Mood Pattern Observation Component comprises sensing a sentiment and an emotion from the sensed interaction.

5. The computer-implemented method of claim 1, wherein computing the prevalent mood pattern in the Mood Pattern Grouping Component comprises executing a clustering algorithm.

6. The computer-implemented method of claim 1, wherein the Text Generation Component comprises a sequence-to-sequence model.

7. The computer-implemented method of claim 1, wherein the Orchestration of Agent Interactions Component comprises a feedback loop based in part on the mood pattern and the sensed interaction.

8. A computer program product comprising one or more computer readable storage media, and program instructions collectively stored on the one or more computer readable storage media, the program instructions executable by a processor to cause the processor to perform operations comprising:
sensing an interaction among a software agent and a plurality of humans, responsive to the sensed interaction, computing a mood pattern in a Mood Pattern Observation Component based on the sensed interaction;
computing a prevalent mood pattern in a Mood Pattern Grouping Component based on the mood pattern; and
deciding by an Orchestration of Agent Interactions Component based on the prevalent mood pattern to adapt a response of the software agent to influence at least one of the plurality of humans towards the prevalent mood pattern, the deciding further comprising:
training a Text Generation Component to generate a text sequence based on the response wherein the software agent emits the text sequence and the sensed interaction among the software agent and the plurality of humans is updated with the text sequence.

9. The computer program product of claim 8, wherein the deciding by the Orchestration of Agent Interactions Component further comprises inputting a prompt into a machine learning model wherein the prompt is based in part on the prevalent mood pattern.

10. The computer program product of claim 8, wherein the computing the prevalent mood pattern in the Mood Pattern Grouping Component further comprises sensing an intensity and a duration of the mood pattern.

11. The computer program product of claim 8, wherein computing the mood pattern in the Mood Pattern Observation Component comprises sensing a sentiment and an emotion from the sensed interaction.

12. The computer program product of claim 8, wherein computing the prevalent mood pattern in the Mood Pattern Grouping Component comprises executing a clustering algorithm.

13. The computer program product of claim 8, wherein the Text Generation Component comprises a sequence-to-sequence model.

14. The computer program product of claim 8, wherein the Orchestration of Agent Interactions Component comprises a feedback loop based in part on the mood pattern and the sensed interaction.

15. A computer system comprising a processor and one or more computer readable storage media, and program instructions collectively stored on the one or more computer readable storage media, the program instructions executable by the processor to cause the processor to perform operations comprising:
sensing an interaction among a software agent and a plurality of humans, responsive to the sensed interaction, computing a mood pattern in a Mood Pattern Observation Component based on the sensed interaction;
computing a prevalent mood pattern in a Mood Pattern Grouping Component based on the mood pattern; and
deciding by an Orchestration of Agent Interactions Component based on the prevalent mood pattern to adapt a response of the software agent to influence at least one of the plurality of humans towards the prevalent mood pattern, the deciding further comprising:
training a Text Generation Component to generate a text sequence based on the response wherein the software agent emits the text sequence and the sensed interaction among the software agent and the plurality of humans is updated with the text sequence.

16. The computer system of claim 15, wherein the deciding by the Orchestration of Agent Interactions Component further comprises inputting a prompt into a machine learning model wherein the prompt is based in part on the prevalent mood pattern.

17. The computer system of claim 15, wherein the computing the prevalent mood pattern in the Mood Pattern Grouping Component further comprises sensing an intensity and a duration of the mood pattern.

18. The computer system of claim 15, wherein computing the mood pattern in the Mood Pattern Observation Component comprises sensing a sentiment and an emotion from the sensed interaction.

19. The computer system of claim 15, wherein the Text Generation Component comprises a sequence-to-sequence model.

20. The computer system of claim 15, wherein the Orchestration of Agent Interactions Component comprises a feedback loop based in part on the mood pattern and the sensed interaction.
